(19) United States
(12) Patent Application Publication
(10) Pub. No.: US 2022/0356106 A1
(43) Pub. Date: Nov. 10, 2022

(54) APPARATUS AND METHOD FOR CUTTING GLASS LAMINATE

(71) Applicant: CORNING INCORPORATED, CORNING, NY (US)

(72) Inventors: Woo Jin Lee, Cheonan (KR); Cheol Hee Park, Asan-si (KR); Dong Keun Shin, Hwasung-si (KR)

(21) Appl. No.: 17/636,070

(22) PCT Filed: Aug. 7, 2020
(86) PCT No.: PCT/US2020/045308

§ 371 Date: Feb. 17, 2022

(30) Foreign Application Priority Data
Aug. 20, 2019 (KR) 10-2019-0101875

(51) Int. Cl. C03B 33/07; C03B 33/03

(52) U.S. Cl. CPC C03B 33/07; C03B 33/03

(57) ABSTRACT

Provided are an apparatus and method for cutting a glass laminate The apparatus comprises a first and second part spaced apart from each other by a first gap, a first guide block and a second guide block spaced apart from each other by a second gap, wherein a saw blade is able to pass through first and second gaps, a first fixing unit and second fixing unit, each capable of fixing the respective first guide block and second guide block to the respective first part and second part of the table, and thus defining a space for a glass laminate.

### CROSS-REFERENCE TO RELATED APPLICATION

This application claims the benefit of Korean Patent Application No. 10-2019-0101875, filed on Aug. 20, 2019, in the Korean Intellectual Property Office, the disclosure of which is incorporated herein in its entirety by reference.

### BACKGROUND

### Field

The inventive concept relates to a cutting apparatus and a cutting method. More particularly, the inventive concept relates to an apparatus and method for cutting a glass laminate.

### Description of Related Art

A glass laminate may be cut by using various technologies including laser, a CNC router, and a water jet. The conventional glass laminate cutting technologies require huge and expensive apparatuses and complex processes. However, a general user who uses a glass laminate desires a glass laminate to be cut using a simple and cheap apparatus and a simple and easy process.

### SUMMARY

The inventive concept provides a glass laminate cutting apparatus that is simple and cheap so as to be easily used anywhere, anytime, by anyone and a glass laminate cutting method that is simple and easy.

Additional aspects will be set forth in part in the description which follows and, in part, will be apparent from the description, or may be learned by practice of the presented embodiments of the disclosure.

According to an aspect of the inventive concept, there is provided an apparatus for cutting a glass laminate, which comprises a table comprising a first part and a second part spaced apart from each other by a first gap through which a saw blade is able to pass, a first guide block and a second guide block spaced apart from each other by a second gap through which the saw blade is able to pass, a first fixing unit capable of fixing the first guide block to the first part of the table, and a second fixing unit capable of fixing the second guide block to the second part of the table, wherein the first part and the second part of the table, the first guide block, and the second guide block at least partially define a space in which a glass laminate is located.

In some embodiments, each of the first guide block and the second guide block may comprise a cushion that is contactable with a surface of the glass laminate.

In some embodiments, the apparatus may further comprise an alignment block capable of aligning the glass laminate.

In some embodiments, the alignment block may be contactable with at least one edge of the glass laminate.

In some embodiments, the first guide block and the second guide block may be transparent.

In some embodiments, the apparatus may further comprise an additional fixing unit capable of fixing the glass laminate to the table.

In some embodiments, the additional fixing unit may comprise a magnet in the table.

In some embodiments, the first fixing unit may comprise a magnet in the first part of the table and a magnet in the first guide block, and the second fixing unit may comprise a magnet in the second part of the table and a magnet in the second guide block.

In some embodiments, the table may comprise material that has a hardness less than a hardness of a material of the saw blade.

In some embodiments, each of the first guide block and the second guide block may comprise material that has a hardness less than a hardness of a material of the saw blade.

Furthermore, according to an aspect of the inventive concept, there is provided an apparatus for cutting a glass laminate, which include a table comprising a first part and a second part spaced apart from each other in a first horizontal direction by a first gap, a first guide block separable from the first part of the table in a vertical direction, a second guide block separable from the second part of the table in the vertical direction, a pair of first fixing units, each extending in the vertical direction to pass through a hole in the first guide block and a hole in the first part of the table, and a pair of second fixing units, each extending in the vertical direction to pass through a hole in the second guide block and a hole in the second part of the table, wherein the first guide block and the second guide block are spaced apart from each other in the first horizontal direction by a second gap.

In some embodiments, a width of the second gap in the first horizontal direction may be adjustable.

In some embodiments, each of the hole in the first guide block and the hole in the second guide block may have a cross-section elongated in the first horizontal direction.

In some embodiments, the first guide block may comprise a cushion facing the first part of the table, and the second guide block may comprise a cushion facing the second part of the table.

In some embodiments, the apparatus may further comprise an alignment block on the first part of the table.

In some embodiments, the alignment block may comprise a portion extending in a second horizontal direction perpendicular to the first horizontal direction.

In some embodiments, the alignment block may further comprise a portion extending in the first horizontal direction.

In some embodiments, the alignment block may comprise a plurality of alignment blocks.

Furthermore, according to an aspect of the inventive concept, there is provided a method of cutting a glass laminate, which comprises placing a glass laminate on a table comprising a first part and a second part spaced apart from each other in a horizontal direction by a first gap, fixing the first guide block to the first part of the table using a first fixing unit to allow the glass laminate to be fixed between a first guide block and the first part of the table, fixing the second guide block to the second part of the table using a second fixing unit to allow the glass laminate to be fixed between a second guide block and the second part of the table and to allow the first guide block and the second guide block to be spaced apart from each other in the horizontal direction by a second gap, and moving a saw blade within a cutting path that is at least partially defined by the first gap and the second gap.

In some embodiments, the fixing of the first guide block to the first part of the table may comprise allowing a cushion of the first guide block to contact the glass laminate, and the fixing of the second guide block to the second part of the table may include allowing a cushion of the second guide block to contact the glass laminate.

In some embodiments, during the moving of the saw blade, a coolant may be supplied into the second gap.

In some embodiments, the method may further comprise aligning the glass laminate to allow at least one edge of the glass laminate to contact an alignment block.

In some embodiments, the moving of the saw blade may comprise forming a relief cut along the cutting path from an end of the cutting path and forming a main cut along the cutting path from the other end of the cutting path to the relief cut.

In some embodiments, a width of the first gap in the horizontal direction may be greater than a width of the second gap in the horizontal direction.

In some embodiment, a width of the first gap in the horizontal direction may be from about 1.5 times to about 2.5 times a thickness of the saw blade.

In some embodiment, a width of the second gap in the horizontal direction may be from about 1.0 times to about 1.5 times a thickness of the saw blade.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of a glass laminate.

FIG. 2 is a plan view of a glass laminate cutting apparatus according to an embodiment of the present disclosure.

FIG. 3 is a cross-sectional view taken along line A-A′ of FIG. 2.

FIG. 4 is a cross-sectional view taken along line B-B′ of FIG. 2.

FIG. 5 is a perspective view of a glass laminate cutting apparatus according to an embodiment of the present disclosure.

FIG. 6 is a plan view of a glass laminate cutting apparatus according to an embodiment of the present disclosure.

FIG. 7 is a plan view of a glass laminate cutting apparatus according to an embodiment of the present disclosure.

FIG. 8 is a plan view of a glass laminate cutting apparatus according to an embodiment of the present disclosure.

FIG. 9 is a cross-sectional view of a glass laminate cutting apparatus according to an embodiment of the present disclosure.

FIG. 10 is a cross-sectional view of a glass laminate cutting apparatus according to an embodiment of the present disclosure.

FIG. 11 is a cross-sectional view of a glass laminate cutting apparatus according to an embodiment of the present disclosure.

FIG. 12 is a flowchart of a glass laminate cutting method according to an embodiment of the present disclosure.

FIGS. 13A to 13G illustrate a glass laminate cutting method according to an embodiment of the present disclosure.

FIG. 14 is a graph showing a comparison of an edge strength between a glass laminate, which is cut by using an apparatus for cutting a glass laminate according to an embodiment of the present disclosure and a glass laminate cutting method according to an embodiment of the present disclosure, and a glass laminate cut by using an apparatus and method according to a comparative example.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Throughout the drawings, like reference numerals denote like elements. Furthermore, various elements illustrated in the drawings are merely schematically illustrated. Accordingly, some elements may be exaggerated for the purpose of explanation, and may not be limited by relative dimensions presented in the accompanying drawings. Furthermore, directional terms, such as “upper,” lower,” “left”, “right” and the like, may be used herein with reference to the drawings, and it will be understood that the directional terms are not intended to denote absolute orientation.

In the present specification, the expression of singularity includes the expression of plurality unless clearly specified otherwise in context. For example, an embodiment including A includes an embodiment including two or more A's unless clearly specified otherwise in context. Furthermore, an embodiment comprising an element(s) in the present specification does not exclude addition of a further element(s). For example, an embodiment comprising A, B, and C includes an embodiment comprising A, B, C, and D.

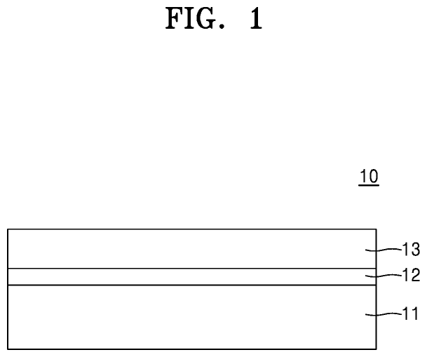

FIG. 1 is a cross-sectional view of a glass laminate 10.

Referring to FIG. 1, the glass laminate 10 may comprise a substrate 11, an adhesive layer 12 on the substrate 11, and a glass layer 13 on the adhesive layer 12. The substrate 11 may comprise a material, for example, metal, wood, inorganics, organics, or a combination thereof, but the present disclosure is not limited thereto. In some embodiments, the substrate 11 may comprise a high pressure laminate (HPL), paint-coated metal (PCM), a medium density fiberboard (MDF), vinyl-coated metal (VCM), or steel, but the present disclosure is not limited thereto.

The glass layer 13 may comprise, for example, borosilicate, aluminosilicate, boroaluminosilicate, alkali borosilicate, alkali aluminosilicate, alkali boroaluminosilicate, or soda lime, but the present disclosure is not limited thereto. The thickness of the glass layer 13 may be, for example, about 0.1 mm to about 2.0 mm.

The adhesive layer 12 may attach the glass layer 13 to the substrate 11. For example, the adhesive layer 12 may comprise a pressure sensitive adhesive (PSA) or an optically clear adhesive (OCA), but the present disclosure is not limited thereto. The thickness of the adhesive layer 12 may be, for example, about 0.01 mm to about 1.0 mm.

An apparatus and method for cutting the glass laminate 10 is described below.

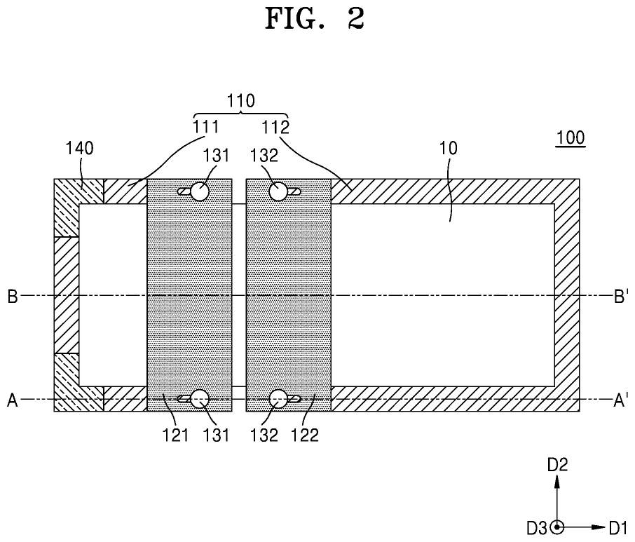

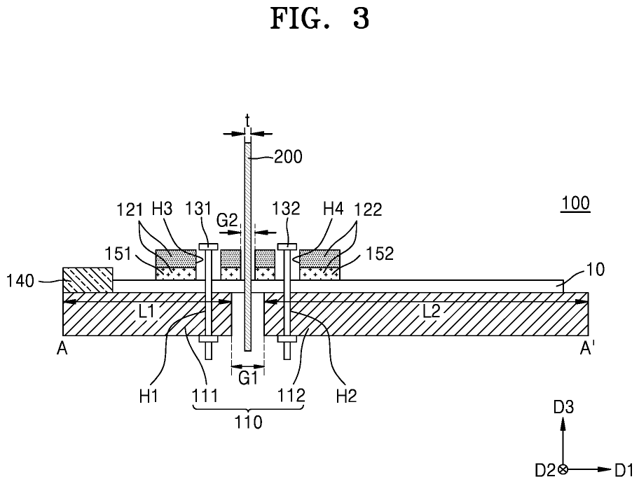

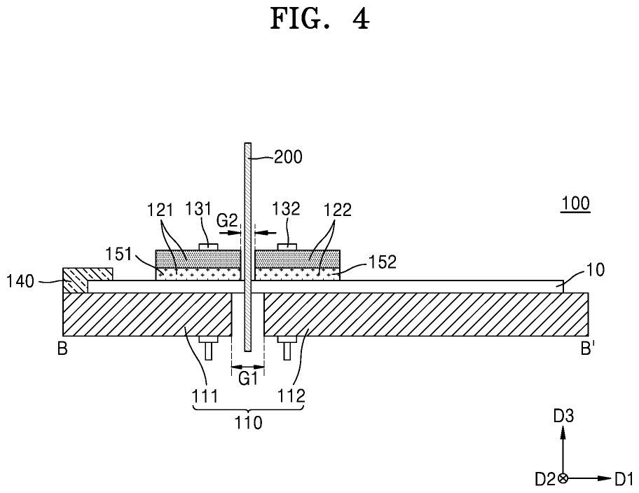

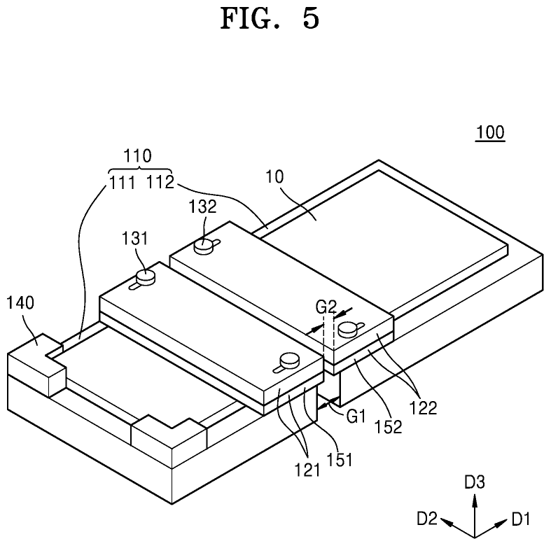

FIG. 2 is a plan view of an apparatus 100 for cutting the glass laminate 10 according to an embodiment of the present disclosure. FIG. 3 is a cross-sectional view taken along line A-A′ of FIG. 2. FIG. 4 is a cross-sectional view taken along line B-B′ of FIG. 2. FIG. 5 is a perspective view of the apparatus 100 for cutting the glass laminate 10 according to an embodiment of the present disclosure.

Referring to FIGS. 2 to 5, the glass laminate cutting apparatus 100 according to an embodiment of the present disclosure may comprise a table 110, a first guide block 121, a second guide block 122, a first fixing unit 131, and a second fixing unit 132.

The glass laminate 10 may be placed on the table 110. The table 110 may comprise a first part 111 and a second part 112 which are separated from each other by a first gap G1 in a first horizontal direction (direction D1). In some embodiments, a length L1 of the first part 111 of the table 110 in the first horizontal direction (direction D1) and a length L2 of the second part 112 of the table 110 in the first horizontal direction (direction D1) may be different from each other. However, In another embodiment, the length L1 of the first part 111 of the table 110 in the first horizontal direction (direction D1) and the length L2 of the second part 112 of the table 110 in the first horizontal direction (direction D1) may be substantially the same. In order to prevent a blade of a saw 200 from being worn out when the glass laminate 10 is cut, the table 110 may comprise a material softer than a blade of a saw 200 used for cutting the glass laminate 10, that is, a material having a hardness less than that of the blade. For example, the table 110 may comprise poly vinyl chloride (PVC). In some embodiments, the table 110 may comprise a magnet. When the substrate 11 (see FIG. 1) of the glass laminate 10 comprises a magnetic material, the glass laminate 10 may be fixed to the table 110 by a magnetic force.

The first gap G1 may extend in a second horizontal direction (direction D2) perpendicular to the first horizontal direction (direction D1) with a constant width in the first horizontal direction (direction D1). The width of the first gap G1 in the first horizontal direction (direction D1) may be slightly greater than a thickness t of the blade of the saw 200. For example, the width of the first gap G1 in the first horizontal direction (direction D1) may be about 1 time to about 3 times, for example, about 1.5 times to about 2.5 times the thickness t of the blade of the saw 200. Accordingly, the blade of the saw 200 may pass through the first gap G1. In some embodiments, the thickness t of the blade of the saw 200 may be about 0.1 mm to about 2.0 mm. The thickness t of the blade of the saw 200 may be defined by a maximum distance in the first horizontal direction (direction D1) between a surface of the blade of the saw 200 facing the first part 111 of the table 110 and a surface of the blade of the saw 200 facing the second part 112 of the table 110 when the blade of the saw 200 is inserted in the first gap G1.

In some embodiments, the first part 111 and the second part 112 of the table 110 each may have a rectangular panel shape. However, each of the first part 111 and the second part 112 of the table 110 may have any shape.

In some embodiments, the first part 111 of the table 110 may have a pair of holes H1. Each of the holes H1 may extend in a vertical direction (direction D3) with a circular cross section. In some embodiments, the holes H1 may be spaced apart from each other in the second horizontal direction (direction D2). In some embodiments, the second part 112 of the table 110 may have a pair of holes H2. Each of the holes H2 may extend in the vertical direction (direction D3) with a circular cross section. In some embodiments, the holes H2 may be spaced apart from each other in the second horizontal direction (direction D2).

The first guide block 121 and the second guide block 122 may be placed on the glass laminate 10. In other words, the first part 111 and the second part 112 of the table 110, the first guide block 121, and the second guide block 122 may at least partially define a space where the glass laminate 10 may be disposed. The first guide block 121 may be spaced apart by the glass laminate 10 from the first part 111 of the table 110 in the vertical direction (direction D3), and the second guide block 122 may be spaced apart by the glass laminate 10 from the second part 112 of the table 110 in the vertical direction (direction D3).

The first guide block 121 and the second guide block 122 may be spaced apart from each other by a second gap G2 in the first horizontal direction (direction D1). The second gap G2 may extend in the second horizontal direction (direction D2) with a constant width in the first horizontal direction (direction D1). In other words, the second gap G2 may extend in a direction in which the first gap G1 extends. The width of the second gap G2 in the first horizontal direction (direction D1) may be slightly greater than the thickness t of the blade of the saw 200. For example, the width of the second gap G2 in the first horizontal direction (direction D1) may be about 1 time to about 2 times, for example, about 1.0 time to about 1.5 times the thickness t of the blade of the saw 200. Accordingly, the blade of the saw 200 may pass through the second gap G2. In some embodiments, the width of the second gap G2 in the first horizontal direction (direction D1) may be less than the width of the first gap G1 in the first horizontal direction (direction D1).

The second gap G2 may be spaced apart from the first gap G1 in the vertical direction (direction D3). In some embodiments, the second gap G2 may be vertically aligned on the first gap G1. The first gap G1 and the second gap G2 may at least partially define a cutting path along which the glass laminate 10 is cut. The blade of the saw 200 may move along the cutting path.

In some embodiments, the first guide block 121 and the second guide block 122 each may have a rectangular box shape. However, each of the first guide block 121 and the second guide block 122 may have any shape.

In some embodiments, the first guide block 121 and the second guide block 122 may be transparent. Accordingly, a user can cut the glass laminate 10 while observing a cutting area of the glass laminate 10. However, in another embodiment, the first guide block 121 and the second guide block 122 may be opaque. In order to prevent the blade of the saw 200 from being worn out during cutting of glass laminate 10, the first guide block 121 and the second guide block 122 may comprise a material softer than the blade of the saw 200 used for cutting the glass laminate 10, that is a material having a hardness less than that of the blade. For example, the first guide block 121 and the second guide block 122 may comprise PVC. In some embodiments, each of the first guide block 121 and the second guide block 122 may comprise a magnet. When the substrate 11 (see FIG. 1) of the glass laminate 10 comprises a magnetic material, the glass laminate 10 may be fixed to the first guide block 121 and the second guide block 122 by a magnetic force.

In some embodiments, the first guide block 121 may comprise a cushion 151 that may contact a surface of the glass laminate 10, and the second guide block 122 may include a cushion 152 that may contact the surface of the glass laminate 10. In other words, the first guide block 121 may comprise the cushion 151 facing the first part 111 of the table 110, and the second guide block 122 may comprise the cushion 152 facing the second part 112 of the table 110. The cushions 151 and 152 may allow the first guide block 121 and the second guide block 122 to contact the glass laminate 10 while not damaging or less damaging the glass laminate 10. The cushions 151 and 152 may comprise sponge, rubber, or other elastic material.

In some embodiments, the first guide block 121 may have a pair of holes H3. Each of the holes H3 may penetrate the first guide block 121 in the vertical direction (direction D3). In some embodiments, each of the holes H3 may have a cross section elongated in the first horizontal direction (direction D1). As the holes H3 have a cross section elongated in the first horizontal direction (direction D1), the position of the first guide block 121 in the first horizontal direction (direction D1) may be adjusted. Accordingly, the width of the second gap G2 in the first horizontal direction (direction D1) may be adjusted. However, in another embodiment, each of the holes H3 may have a circular cross section.

In some embodiments, the second guide block 122 may have a pair of holes H4. Each of the holes H4 may penetrate the second guide block 122 in the vertical direction (direction D3). In some embodiments, each of the holes H4 may have a cross section elongated in the first horizontal direction (direction D1). As the holes H4 have a cross section elongated in the first horizontal direction (direction D1), the position of the second guide block 122 in the first horizontal direction (direction D1) may be adjusted. Accordingly the width of the second gap G2 in the first horizontal direction (direction D1) may be adjusted. However, in another embodiment, each of the holes H4 may have a circular cross section.

The first fixing units 131 may fix the first guide block 121 to the first part 111 of the table 110. Furthermore, the first fixing units 131 may fix the glass laminate 10 with the first guide block 121. In some embodiments, the first fixing units 131 may comprise bolts and nuts. For example, each of the first fixing units 131 may extend in the vertical direction (direction D3) to penetrate the holes H3 in the first guide block 121 and the holes H1 in the first part 111 of the table 110. However, in another embodiment, the first fixing units 131 may comprise other coupling device such as a clamp. For example, the first fixing units 131 may comprise the magnet in the table 110 and the magnet in the first guide block 121.The second fixing units 132 may fix the second guide block 122 to the second part 112 of the table 110. Furthermore, the second fixing units 132 may fix the glass laminate 10 with the second guide block 122. In some embodiments, the second fixing units 132 may comprise bolts and nuts. For example, each of the second fixing units 132 may extend in the vertical direction (direction D3) to penetrate the holes H4 of the second guide block 122 and the holes H2 in the second part 112 of the table 110. However, in another embodiment, the second fixing units 132 may comprise other coupling device such as a clamp. For example, the second fixing units 132 may comprise the magnet in the table 110 and the magnet in the second guide block 122. When the substrate 11 (see FIG. 1) of the glass laminate 10 comprises a magnetic material, the glass laminate 10 may be fixed to the table 110 and the second guide block 122 by a magnetic force.

In some embodiments, the apparatus 100 for cutting the glass laminate 10 may further comprise an alignment block 140 on the first part 111 of the table 110. In some embodiments, the apparatus 100 for cutting the glass laminate 10 may further comprise a plurality of alignment blocks 140. Although FIGS. 2 to 5 illustrate that the apparatus 100 for cutting the glass laminate 10 comprises two alignment blocks 140, the apparatus 100 for cutting the glass laminate 10 may include one alignment block, or three or more alignment blocks. The alignment block 140 may align the position and/or orientation of the glass laminate 10 on the table 110.

In some embodiments, the alignment block 140 may comprise a portion extending in the first horizontal direction (direction D1) and a portion extending in the second horizontal direction (direction D2) from an end of the portion extending in the first horizontal direction (direction D1). In other words, the alignment block 140 may have an “L” shape. However, the shape of the alignment block 140 is not limited thereto. The alignment block 140 may contact at least one edge of the glass laminate 10. For example, when the glass laminate 10 has two edges parallel to each other and extending in the first horizontal direction (direction D1) and two edges parallel to each other and extending in the second horizontal direction (direction D2), and the alignment block 140 comprises a portion extending in the first horizontal direction (direction D1) and a portion extending in the second horizontal direction (direction D2) from an end of the portion extending in the first horizontal direction (direction D1), the portion of the alignment block 140 extending in the first horizontal direction (direction D1) may contact the edge of the glass laminate 10 extending in the first horizontal direction (direction D1), and the portion of the alignment block 140 extending in the second horizontal direction (direction D2) may contact the edge of the glass laminate 10 extending in the second horizontal direction (direction D2). In another embodiment, the alignment block 140 may contact only one edge of the glass laminate 10.

The apparatus 100 for cutting the glass laminate 10 according to an embodiment of the present disclosure may be small, simple, and cheap. Accordingly, the glass laminate 10 may be cut simply and cheaply without huge equipment by using the saw 200 that is commercially obtainable and the apparatus 100 for cutting the glass laminate 10.

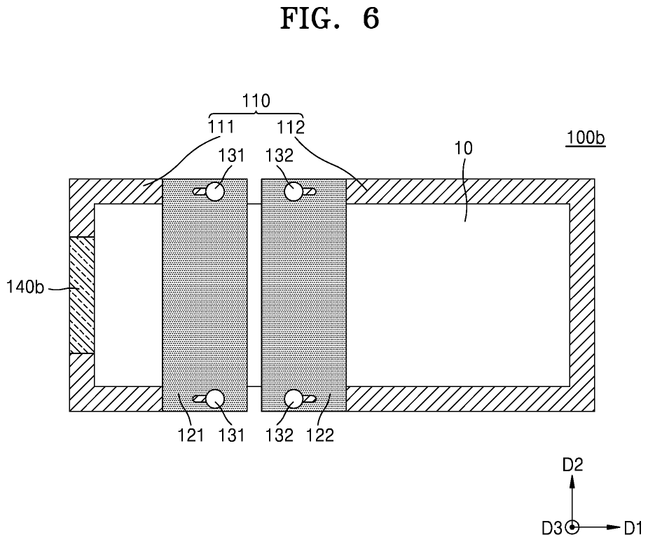

FIG. 6 is a plan view of an apparatus 100b for cutting the glass laminate 10 according to an embodiment of the present disclosure. The apparatus 100b for cutting the glass laminate 10 may comprise an alignment block 140b. The alignment block 140b may extend in the second horizontal direction (direction D2). The edge of the glass laminate 10 extending in the second horizontal direction (direction D2) may contact the alignment block 140b. Although FIG. 6 illustrates that the apparatus 100b for cutting the glass laminate 10 comprises only one alignment block 140b, the apparatus 100b for cutting the glass laminate 10 may comprise a plurality of alignment blocks 140b. For example, the alignment blocks 140b may be disposed in the second horizontal direction (direction D2). In another embodiment, the alignment block 140b may extend, unlike FIG. 6, in the first horizontal direction (direction D1). The edge of the glass laminate 10 extending in the first horizontal direction (direction D1) and the alignment block 140b may be in contact with each other. In another embodiment, the apparatus 100b for cutting the glass laminate 10 may comprise three alignment blocks spaced apart from one another. One of three alignment blocks may extend in the second horizontal direction (direction D2) and two of the three alignment blocks may extend in the first horizontal direction (direction D1).

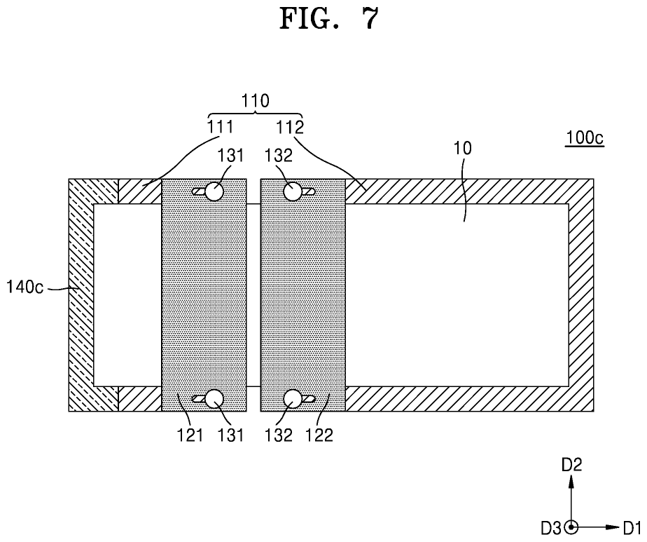

FIG. 7 is a plan view of an apparatus 100c for cutting the glass laminate 10 according to an embodiment of the present disclosure.

Referring to FIG. 7, the apparatus 100c for cutting the glass laminate 10 may comprise an alignment block 140c. The alignment block 140c may comprise a portion extending in the second horizontal direction (direction D2), the portion extending in the first horizontal direction (direction D1) from an end of the portion extending in the second horizontal direction (direction D2), and the portion extending in the first horizontal direction (direction D1) from the other end of the portion extending in the second horizontal direction (direction D2). The alignment block 140c may contact three edges of the glass laminate 10. For example, a portion of the alignment block 140c extending in the second horizontal direction (direction D2) may contact the edge of the glass laminate 10 extending in the second horizontal direction (direction D2), a portion of the alignment block 140c extending in the first horizontal direction (direction D1) may contact the edge of the glass laminate 10 extending in the first horizontal direction (direction D1), and the other portion of the alignment block 140c extending in the first horizontal direction (direction D1) may contact the other edge of the glass laminate 10 extending in the first horizontal direction (direction D1). As such, the apparatuses 100, 100b, and 100c for cutting the glass laminate 10 may comprise the alignment blocks 140, 140b, and140c of any number and any shape.

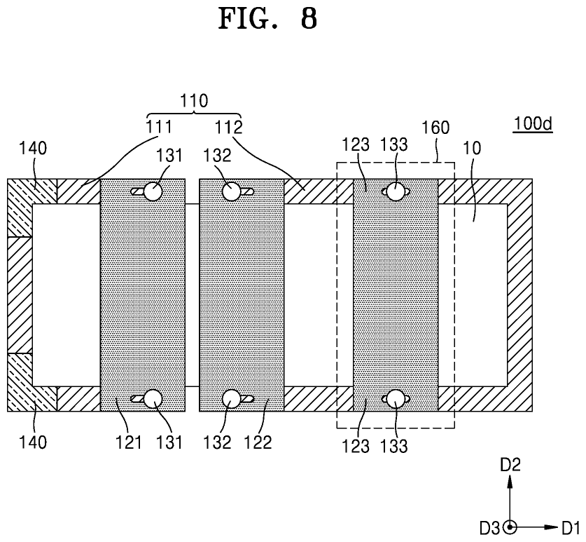

FIG. 8 is a plan view of a glass laminate cutting apparatus 100d according to an embodiment of the present disclosure.

Referring to FIG. 8, the apparatus 100d for cutting the glass laminate 10 may comprise an additional fixing unit 160. The additional fixing unit 160 may fix the glass laminate 10 to the table 110. The additional fixing unit 160 may comprise, for example, a third guide block 123 and a pair of third fixing units 133. The third guide block 123 may be placed on the glass laminate 10. In other words, the third guide block 123 may be spaced apart by the glass laminate 10 from the second part 112 of the table 110 in the vertical direction (direction D3). The third fixing units 133 fix the third guide block 123 to the second part 112 of the table 110, thereby fixing the glass laminate 10 to the table 110. Each third guide block 123 may comprise, for example, bolts and nuts. Each third guide block 123 may penetrate a hole in the third guide block 123 and the hole in the table 110 and extend in the vertical direction (direction D3).

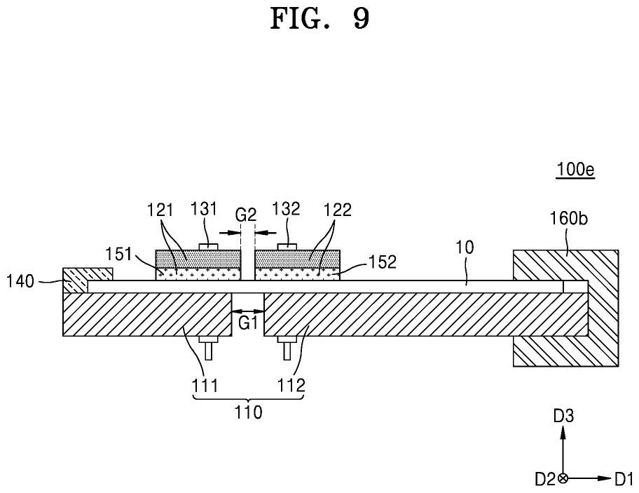

FIG. 9 is a cross-sectional view of a glass laminate cutting apparatus 100e according to an embodiment of the present disclosure.

Referring to FIG. 9, the apparatus 100e for cutting the glass laminate 10 may comprise an additional fixing unit 160b. The additional fixing unit 160b may be, for example, a clamp. The additional fixing unit 160b may fix one end of the glass laminate 10 to the second part 112 of the table 110. In another embodiment, the apparatus 100e for cutting the glass laminate 10 may comprise a pair of fixing units 160b. The fixing units 160b may fix both sides of the glass laminate 10 to the second part 112 of the table 110.

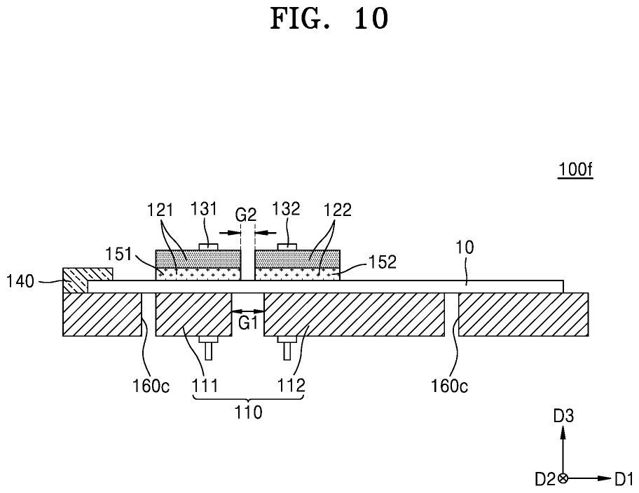

FIG. 10 is a cross-sectional view of a glass laminate cutting apparatus 100f according to an embodiment of the present disclosure.

Referring to FIG. 10, the apparatus 100f for cutting the glass laminate 10 may comprise additional fixing units 160c. The additional fixing units 160c may comprise, for example, vacuum holes. A vacuum pump may be used to form vacuum in the additional fixing units 160c. The additional fixing units 160c may be located in at least one of the first part 111 and the second part 112 of the table 110. The glass laminate 10 may be fixed to the table 110 due to a pressure difference generated by the additional fixing units 160c.

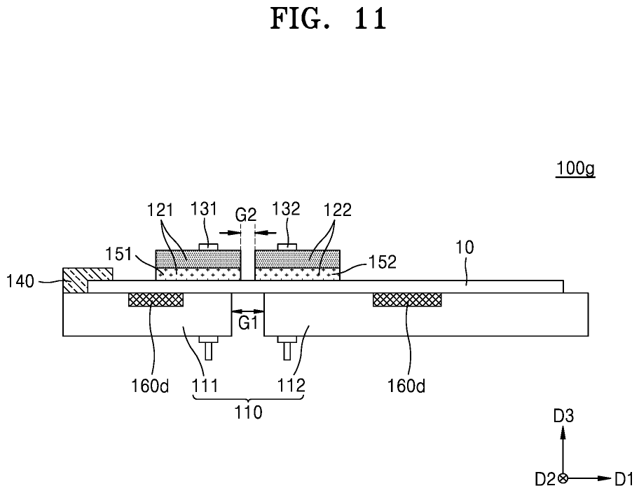

FIG. 11 is a cross-sectional view of a glass laminate cutting apparatus 100g according to an embodiment of the present disclosure.

Referring to FIG. 11, the apparatus 100g for cutting the glass laminate 10 may comprise additional fixing units 160d. The additional fixing units 160d may include, for example, magnets. The additional fixing units 160d may be located in at least one of the first part 111 and the second part 112 of the table 110. When the substrate 11 (see FIG. 1) of the glass laminate 10 comprises a magnetic material, the glass laminate 10 may be fixed to the table 110 by a magnetic force.

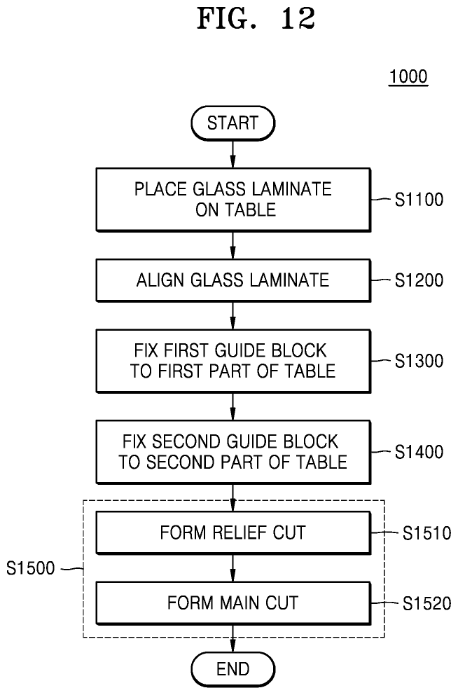

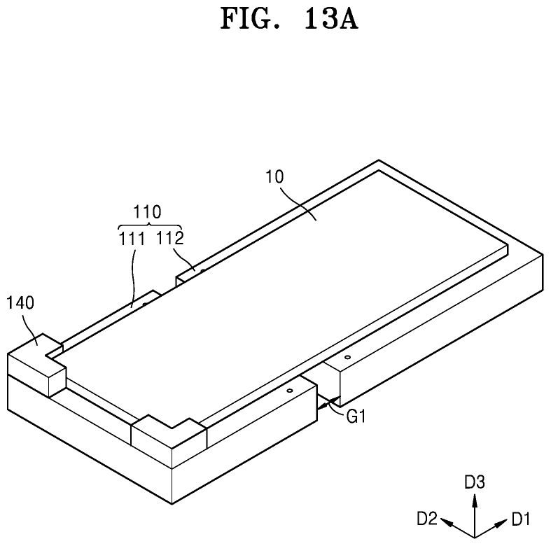

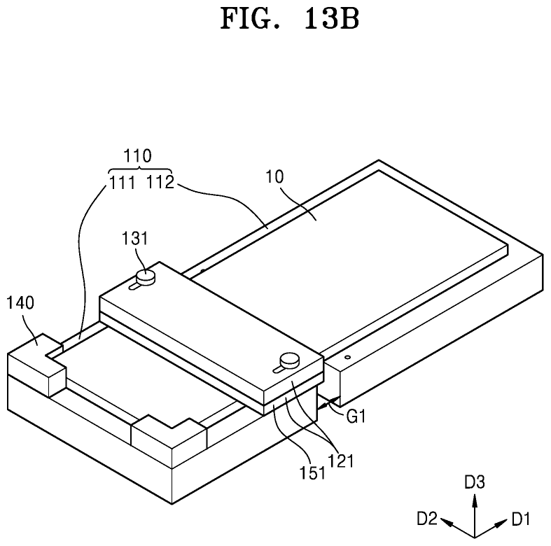

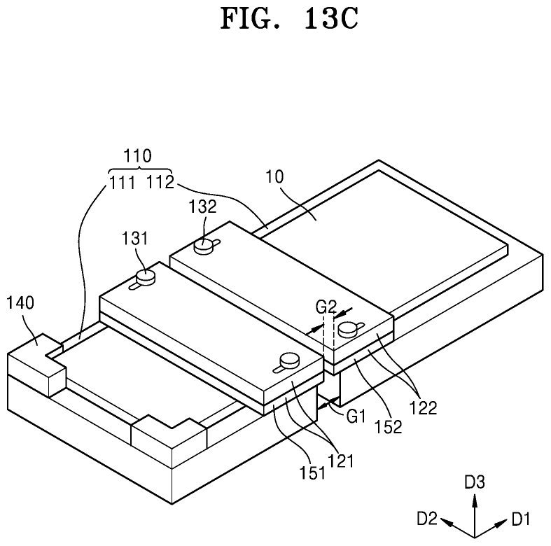

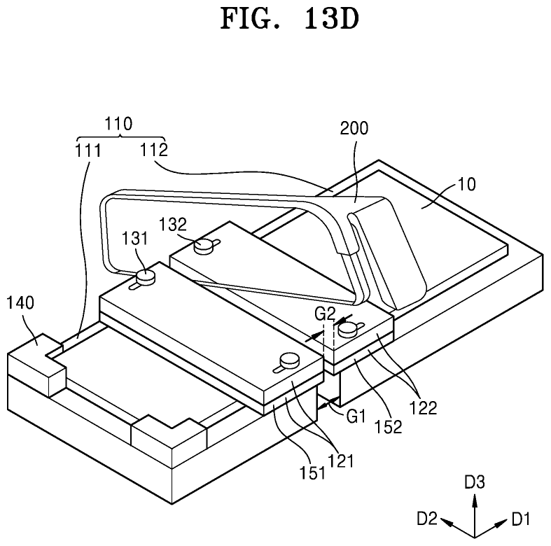

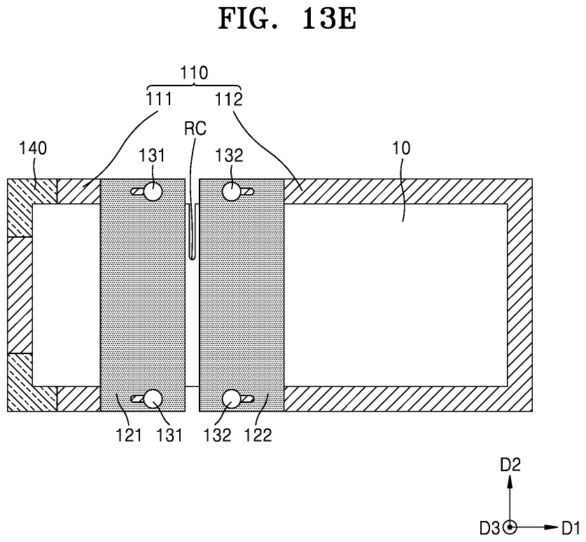

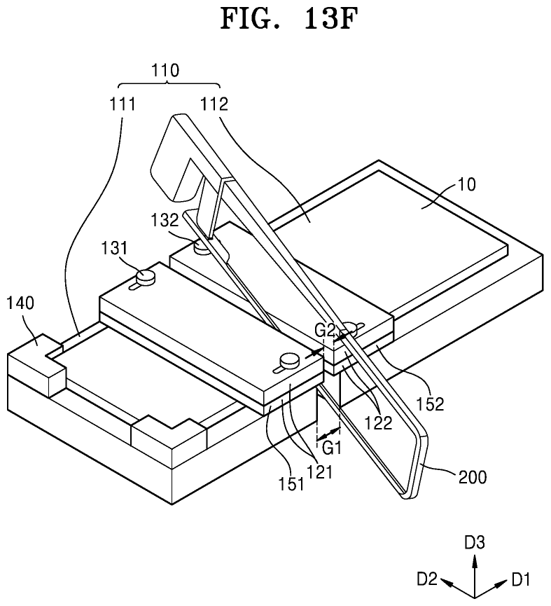

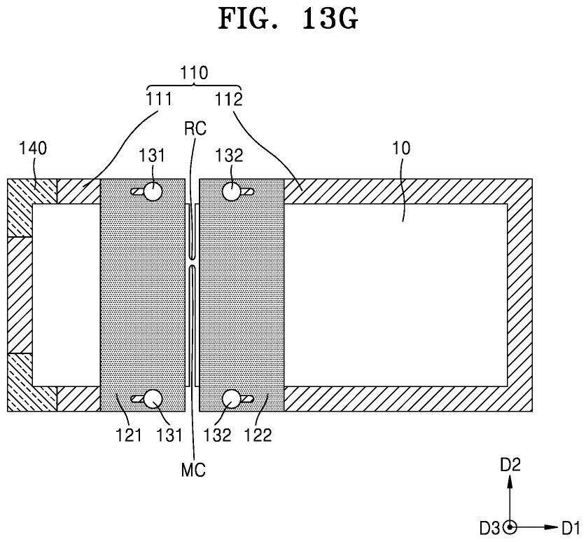

FIG. 12 is a flowchart of a glass laminate cutting method 1000 according to an embodiment of the present disclosure. FIGS. 13A to 13G illustrate the glass laminate cutting method 1000 according to an embodiment of the present disclosure.

Referring to FIGS. 12 and 13A, first, the glass laminate 10 is placed on the table 110 comprising the first part 111 and the second part 112 separated by the first gap G1 from each other (S1100). Next, the glass laminate 10 is aligned on the table 110 by using the alignment block 140 (S1200). For example, at least one of edge of the glass laminate 10 may contact the alignment block 140. In some embodiments, the alignment operation S1200 may be omitted.

Referring to FIGS. 12 and 13B, while the first guide block 121 is placed on the glass laminate 10, the first guide block 121 is fixed to the first part 111 of the table 110 by using the first fixing units 131 (S1300). Accordingly, the glass laminate 10 may be fixed between the first guide block 121 and the first part 111 of the table 110. In some embodiments, the cushion 151 of the first guide block 121 may contact the glass laminate 10.

Referring to FIGS. 12 and 13C, while the second guide block 122 is placed on the glass laminate 10, the second guide block 122 is fixed to the second part 112 of the table 110 by using the second fixing units 132 (S1400). Accordingly, the glass laminate 10 may be fixed between the second guide block 122 and the second part 112 of the table 110. In another embodiment, after the fixing of the second guide block 122 (S1400) is first performed, fixing the first guide block 121 (S1300) may be performed. In some embodiments, the cushion 152 of the second guide block 122 may contact the glass laminate 10.

Referring to FIG. 12 and FIGS. 13D to 13G, the saw 200 is moved within a cutting path that is at least partially defined by the first gap G1 and the second gap G2 (S1500). During the moving of the saw 200 (S1500), a coolant may be supplied to the second gap G2. Accordingly, debris generated during the cutting of the glass laminate 10 may be removed. In some embodiments, the moving of the saw 200 (S1500) may comprise forming a relief cut RC (S1510) and forming a main cut MC (S1520).

As illustrated in FIGS. 13D and 13E, the relief cut RC may be formed along a part of the cutting path from one end of the cutting path. Then, as illustrated in FIGS. 13F and 13G, the main cut MC is formed along the cutting path from the other end of the cutting path, that is, in a direction opposite to the direction in which the relief cut RC is formed. The main cut MC may finally meet the relief cut RC. Generation of cracks during the cutting of the glass laminate 10 may be prevented by forming the main cut MC (S1520) after the forming of the relief cut RC (S1510).

The glass laminate 10 may be simply cut by using the method 1000 of cutting the glass laminate 10 according to an embodiment of the present disclosure. In particular, when the thickness of the glass layer 13 (see FIG. 1) is thin, for example the thickness of the glass layer 13 is about 0.1 mm to about 0.4 mm, the glass laminate 10 may be simply cut by using the method 1000 of cutting the glass laminate 10 according to an embodiment of the present disclosure. Furthermore, as described below, when the glass laminate 10 is cut according to the method 1000 of cutting the glass laminate 10 and then the cut edge is grinded, an edge strength of a level similar to other cutting method may be obtained.

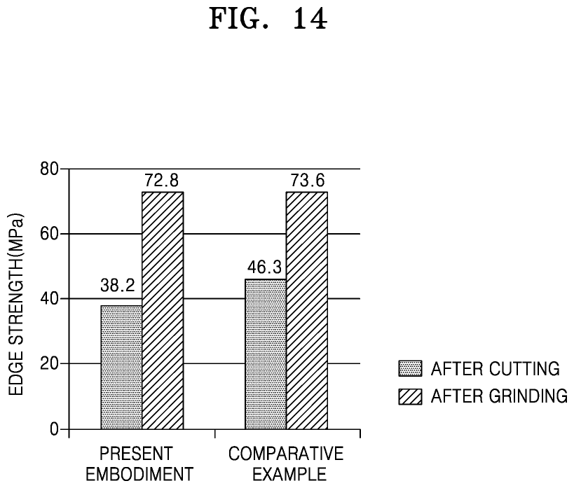

FIG. 14 is a graph showing a comparison of an edge strength between a glass laminate, which is cut by using the apparatus for cutting a glass laminate according to an embodiment of the present disclosure and the glass laminate cutting method according to an embodiment of the present disclosure and a glass laminate cut by using an apparatus and method according to a comparative example.

A glass laminate was cut by using the glass laminate cutting apparatus 100 illustrated in FIGS. 2 to 5, and the saw 200 that was commercially obtainable and the glass laminate cutting method 1000 illustrated in FIGS. 12 to 13G. The width of the first gap G1 in the first horizontal direction (direction D1) was about 1.0 mm, and the width of the second gap G2 in the first horizontal direction (direction D1) was 0.5 mm. A cutting length was about 100 mm, and a cutting speed was about 0.04 m/min. The relief cut RC and the main cut MC were formed by moving the saw 200 back and forth, and water was supplied to the second gap G2 during cutting.

In a comparative example, the glass laminate 10 was cut by using a bench-top band saw that was commercially obtainable. Likewise, a cutting length was 100 mm, and a cutting speed was 0.04 m/min. A blade of the bench-top band saw was moved in one direction only. The main cut MC only was formed without forming of the relief cut RC, and water was supplied during cutting.

The respective edge strengths after glass laminates cut according to the embodiment of the present inventive concept and glass laminates cut according to the comparative example were measured by using a 4 point bending test.

Furthermore, the edges of the glass laminates cut according to the embodiment of the present inventive concept and the glass laminates cut according to the comparative example undergo three grinding steps. First, a cut glass laminate is fixed to a grinding table. In the first grinding step, a 100 grit sanding block was used, a grinding speed was about 0.1 m/min, and an angle between an upper surface of the glass laminate 10 and a grinding surface of the sanding block was about 90°. In the second grinding step, a 400 grit sanding block was used, a grinding speed was about 0.2 m/min, and the angle between the upper surface of the glass laminate 10 and the grinding surface of the sanding block was about 45° to about 70°. In the third grinding step, a 1000 grit sanding block was used, a grinding speed was about 0.2 m/min, and the angle between the upper surface of the glass laminate 10 and the grinding surface of the sanding block was about 45° to 70°. Water was supplied to the edge that was ground during the three grinding steps.

Edge strengths after grinding of the glass laminates cut according to an embodiment of the present inventive concept and the glass laminates cut according to the comparative example were measured by using a 4 point bending test.

Edge strengths of lower 10% after cutting and after grinding of the glass laminates cut according to an embodiment of the present inventive concept and the glass laminates cut according to the comparative example are shown in FIG. 14. Referring to FIG. 14, when edge strengths after cutting are compared with each other, the edge strength of a glass laminate cut according to the embodiment is slightly lower than the edge strength of a glass laminate cut according to the comparative example. However, the glass laminate cutting apparatus 100 according to the embodiment is simpler and cheaper than the glass laminate cutting apparatus (bench-top band saw) according to the comparative example. When comparing edge strengths after grinding, the edge strength of a glass laminate cut according to the embodiment is almost similar to the edge strength of a glass laminate cut according to the comparative example. In other words, when a grinding step is added, a laminate may be cut simply and cheaply, without complex equipment, by using the glass laminate cutting method 1000 and the glass laminate cutting apparatus 100 according to the embodiment glass laminate, and an edge strength of a level similar to that of the glass laminate cutting method according to the comparative example may be obtained.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. An apparatus for cutting a glass laminate, the apparatus comprising:
a table comprising a first part and a second part spaced apart from each other by a first gap through which a saw blade is able to pass;
a first guide block and a second guide block spaced apart from each other by a second gap through which the saw blade is able to pass;
a first fixing unit capable of fixing the first guide block to the first part of the table; and
a second fixing unit capable of fixing the second guide block to the second part of the table,
wherein the first part and the second part of the table, the first guide block, and the second guide block at least partially define a space in which a glass laminate is located.

2. The apparatus of claim 1, wherein each of the first guide block and the second guide block comprises a cushion that is contactable with a surface of the glass laminate.

3. The apparatus of claim 1, further comprising an alignment block capable of aligning the glass laminate.

4. The apparatus of claim 3, wherein the alignment block is contactable with at least one edge of the glass laminate.

5. The apparatus of claim 1, wherein the first guide block and the second guide block are transparent.

6. The apparatus of claim 1, further comprising an additional fixing unit capable of fixing the glass laminate to the table.

7. The apparatus of claim 6, wherein the additional fixing unit comprises a magnet in the table.

8. The apparatus of claim 1, wherein the first fixing unit comprises a magnet in the first part of the table and a magnet in the first guide block, and the second fixing unit comprises a magnet in the second part of the table and a magnet in the second guide block.

9. The apparatus of claim 1, wherein the table comprises material that has a hardness less than a hardness of a material of the saw blade.

10. The apparatus of claim 1, wherein each of the first guide block and the second guide block comprises material that has a hardness less than a hardness of a material of the saw blade.

11. An apparatus for cutting a glass laminate, the apparatus comprising:
a table comprising a first part and a second part spaced apart from each other in a first horizontal direction by a first gap;
a first guide block separable from the first part of the table in a vertical direction;
a second guide block separable from the second part of the table in the vertical direction;
a pair of first fixing units, each extending in the vertical direction to pass through a hole in the first guide block and a hole in the first part of the table; and
a pair of second fixing units, each extending in the vertical direction to pass through a hole in the second guide block and a hole in the second part of the table,
wherein the first guide block and the second guide block are spaced apart from each other in the first horizontal direction by a second gap.

12. The apparatus of claim 11, wherein a width of the second gap in the first horizontal direction is adjustable.

13. The apparatus of claim 12, wherein each of the hole in the first guide block and the hole in the second guide block has a cross-section elongated in the first horizontal direction.

14. The apparatus of claim 11, wherein
the first guide block comprises a cushion facing the first part of the table, and
the second guide block comprises a cushion facing the second part of the table.

15. The apparatus of claim 11, further comprising an alignment block on the first part of the table.

16. The apparatus of claim 15, wherein the alignment block comprises a portion extending in a second horizontal direction perpendicular to the first horizontal direction.

17. The apparatus of claim 16, wherein the alignment block further comprises a portion extending in the first horizontal direction.

18. The apparatus of claim 15, wherein the alignment block comprises a plurality of alignment blocks.

19.-26. (canceled)
